(19) United States
(12) Patent Application Publication
(10) Pub. No.: US 2013/0024045 A1
(43) Pub. Date: Jan. 24, 2013

(54) POWER CONTROL UNIT

(71) Applicants: Takayuki Fujiwara, Yokohama (JP); Mayuko Tanaka, Yokohama (JP)

(72) Inventors: Takayuki Fujiwara, Yokohama (JP); Mayuko Tanaka, Yokohama (JP)

(73) Assignee: Hitachi Consumer Electronics Co., Ltd.

(21) Appl. No.: 13/553,721

(22) Filed: Jul. 19, 2012

(30) Foreign Application Priority Data
Jul. 21, 2011 (JP) 2011-159758

(51) Int. Cl. G06F 1/26; H02J 7/00; H02J 4/00

(52) U.S. Cl. 700/297; 307/39; 320/107

(57) ABSTRACT

A weather information database stores weather information acquired from a weather information provider. A power generation unit selection unit selects a power generation unit with a high generating efficiency from a plurality of power generation units having different power generation schemes, in accordance with the current weather condition. A power generation electric energy database stores the power generation electric energy of a power generation unit, while an electric energy consumption database stores the electric energy consumption of a plurality of electrical appliances. A power transmission destination selection unit selects an electrical appliance whose electric energy consumption is lower than the generated energy from the plurality of electrical appliances, when the past generated energy in the current time zone is lower than the past total electric power consumption, and transmits electric power thereto.

### CLAIM OF PRIORITY

The present application claims priority from Japanese patent application serial no. JP 2011-159758, filed on Jul. 21, 2011, the content of which is hereby incorporated by reference into this application.

### BACKGROUND OF THE INVENTION

(1) Field of the Invention

The present invention relates to a power control unit in a power supply system including a plurality of power generation units and a plurality of electrical appliances.

(2) Description of the Related Art

In recent years, according to a proposed system including a peculiar power generation unit, electric power is supplied to a common electrical appliance, such as an outside light, in an apartment or an office building. A noted power generation unit includes a system using natural energy, for example, a solar power generation system, a wind power generation system, and the like. In relation to this technique, JP A2006-230136 proposes a power generation system with a purpose to “secure sufficient electric energy in a location without sufficient electric power generation, in an individual power supply system having solar power generation and wind power generation and formed in a river area or a national park”.

### SUMMARY OF THE INVENTION

JP A2006-230136 discloses a system for securing sufficient electric energy in a location without sufficient electric power generation, by providing a battery for each of a plurality of power generation units and parallelly connecting them each other to equalize the amount of charge. However, in JP A2006-230136, no consideration is made as to how the plurality of power generation units are selected to be operated and how the electric power is supplied when there are a plurality of electrical appliances.

The present invention has been made in consideration of the above. It is accordingly an object of the present invention to provide a power control unit which controls to efficiently perform power generation in a building including a plurality of power generation units and to efficiently supply the generated electric power to a plurality of electrical appliances.

According to the present invention, there is provided a power control unit which supplies electric power to an electrical appliance from a plurality of power generation units having different power generation schemes, comprising: an information management unit which acquires weather information from a weather information provider; a weather information database which stores the acquired weather information; and a power generation unit selection unit which selects a power generation unit to be operated, by referring to the weather information database, wherein the power generation unit selection unit selects a power generation unit with a high generating efficiency, of the plurality of power generation units in accordance with a current weather condition.

According to the present invention, there is provided a power control unit which supplies electric power to a plurality of electrical appliances from a power generation unit, comprising: an information management unit which acquires information regarding power generation electric energy of the power generation unit and electric power consumption of the plurality of electrical appliances; a power generation electric energy database which stores the acquired power generation electric energy; an electric power consumption database which stores the acquired electric power consumption; and a power transmission destination selection unit which selects an electrical appliance to which power generated by the power generation unit is transmitted, by referring to the power generation electric energy database and the electric power consumption database, wherein the power transmission destination selection unit selects an electrical appliance whose electric power consumption is less than the power generation electric energy, of the plurality of electrical appliances, when past power generation electric energy in a current time zone is lower than past total electric power consumption.

According to the present invention, electric power can efficiently be generated in a building including a plurality of power generation units, and the generated electric power can efficiently be supplied to a plurality of electrical appliances, thereby reducing the usage of the commercial power supply.

### BRIEF DESCRIPTION OF DRAWINGS

FIG. 1 is a whole block diagram showing a first embodiment of a power supply system.

FIG. 2 is a block diagram showing an embodiment of a power control unit 2 of FIG. 1.

FIG. 3 is a diagram showing a flowchart of a process for selecting a power generation system.

FIG. 4 is a diagram showing a flowchart of a process for selecting a power transmission destination.

FIG. 5 is a diagram showing an example of a weather information database 251.

FIG. 6 is a diagram showing an example of a power generation electric energy database 252.

FIG. 7 is a diagram showing an example of an electric energy consumption database 253.

FIG. 8 are diagrams each showing an example of a time transition of power generation electric energy and electric energy consumption.

FIG. 9 are diagrams each showing an example of a time transition of the electric energy consumption of each electrical appliance.

FIG. 10 is a whole block diagram showing a second embodiment of a power supply system.

FIG. 11 is a block diagram showing an embodiment of a power control unit 2 of FIG. 10.

FIG. 12 is a diagram showing a flowchart of a charging process and a process for selecting a power transmission destination.

FIG. 13 is a whole block diagram showing a third embodiment of a power supply system.

FIG. 14 is a block diagram showing an embodiment of the power control unit 2 of FIG. 13.

FIG. 15 is a diagram showing a flowchart of a power generation control and charging control process.

FIG. 16 are diagrams each showing an example of a time transition of power generation electric energy.

### DESCRIPTION OF THE PREFERRED EMBODIMENTS

Preferred embodiments of the present invention will now be described with reference to the drawings. The same or substantially the same parts are denoted with the same numerals in the drawings.

### First Embodiment

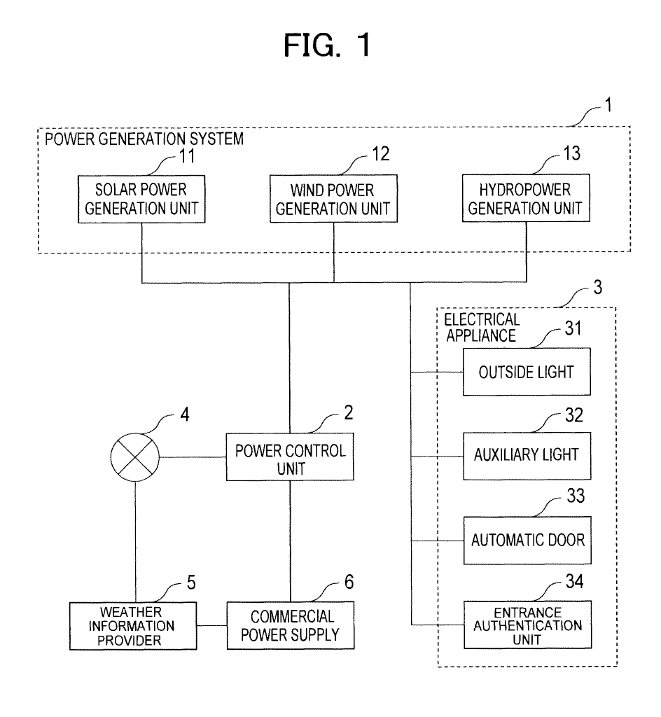

FIG. 1 is a whole block diagram showing the first embodiment of a power supply system in which a power control unit of the present invention is applied, on the assumption of a commonly used electric equipment inside a building, for example, an apartment or an office building. The system configuration includes a power generation system 1 including a plurality of power generation units, an electrical appliance 3 including a plurality of power consuming appliances, and a power control unit 2 controlling the power generation system 1 and controlling the power supply to the electrical appliance 3. Further, the system has a network 4 for acquiring information from external devices. The system is connected to a weather information provider 5 for acquiring weather information, and is connected also to a commercial power supply 6 given from an electric power company. The power generation system 1, the commercial power supply 6, and the electrical appliance 3 are connected with each other through a power cable.

The power generation system 1 has a plurality of power generation units with different power generation schemes, and includes, for example, a solar power generation unit 11, a wind power generation unit 12, and a hydropower generation unit 13. This embodiment will be described based on an example in which these three kinds of power generation units are installed. However, the kinds of the power generation units are not limited to these three, and this embodiment is possible, as long as a plurality of power generation units are provided.

The electrical appliance 3 is a power consuming appliance installed in buildings, and includes an outside light 31 at a building site, an auxiliary light 32 installed in the corridor, automatic door 33, and an entrance authentication unit 34. In this specification, descriptions will be given to an electrical appliance which consumes relatively little power, by way of example. Needless to say, however, the kind of the electrical appliance may be added or changed in accordance with the performance of the power generation system 1.

The weather information provider 5 may be equivalent to Meteorological Agency which keeps and provides data regarding the weather. The commercial power supply 6 supplies electric power from the electric power company. The electric power is used in the event of a shortage of electric power generated by the power generation system 1.

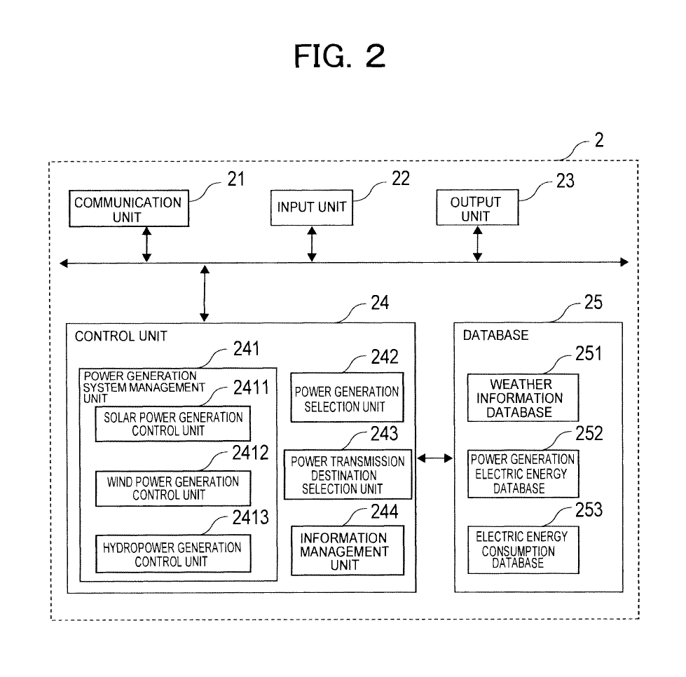

FIG. 2 is a block diagram showing an example of the power control unit 2. The power control unit 2 includes a communication unit 21, an input unit 22, an output unit 23, a control unit 24, and a database 25.

The communication unit 21 acquires weather information from the weather information provider 5 through the network 4, such as the Internet. The communication unit 21 acquires also information regarding power generation electric energy from each of power generation units 11 to 13 through the power cable and also information regarding electric energy consumption from each of electrical appliances 31 to 34. The connection scheme to the network 4 may be any of a wireless LAN (Local Area Network), wireless connection using a mobile communication network, wired connection using a LAN cable, and wired connection using PLC (Power Line Communication). In the wireless scheme, the installation position of the power control unit 2 is arbitrary within the reachable range of radio waves. In the wired communication scheme, high speed and stable communication can be made as compared to the wireless scheme. Particularly, when a PLC adapter is attached to a power cable end of each electrical appliance, using the PLC, a network is built without preparing a new wired LAN cable, thus enabling to acquire the electric energy consumption. When weather information is acquired, receiving equipment to be used may be a TV antenna cable, or an antenna cable which has already been installed in the building may be used.

The input unit 22 is an interface for an administrator to operate the power control unit 2. Examples of the input unit 22 include a button, a switch, dials, a mouse, a keyboard, a touch-panel, and a remote controller.

The output unit 23 outputs GUI (Graphical User Interface) of the power control unit 2, and is a display unit for the administrator to check the response of the power control unit 2. Examples of the output unit 23 include a liquid crystal display monitor, a plasma display monitor, an organic EL display monitor, and a touch-panel display monitor. The output unit 23 may not be installed in the same place as that of the power control unit 2, as long as it can communicate through a LAN (Local Area Network). When the power control unit 2 and output unit 23 are remotely installed, the administrator can efficiently administrate the system using a remote operation. When the output unit 23 is built in the power control unit 2, a hardware trouble of the power control unit 2 can easily be repaired.

The control unit 24 includes a power generation management unit 241, a power generation selection unit, a power transmission destination selection unit 243, and an information management unit 244.

The power generation management unit 241 is to perform a control process for a plurality of power generation units, and includes a solar power generation control unit 2411, a wind power generation control unit 2412, and a hydropower generation control unit 2413. These control units 2411 to 2413 correspond to the power generation units 11 to 13 included in the power generation system 1. The power generation control units 2411 to 2413 control the operation of the power generation units 11 to 13, measure the electric energy generated by the power generation units 11 to 13 and the time zone in which power is generated thereby, and control the transmission of electric power (or charging) generated by the power generation units 11 to 13.

The power generation unit selection unit 242 selects a suitable power generation unit, based on weather information stored in a weather information database 251 (described later) and the past power generation electric energy stored in a power generation electric energy database 252 (described later). Further, when the electric power generation of the power generation system 1 is equal to or lower than a predetermined value, power supplying is switched to power supplying from the commercial power supply 6.

The power transmission destination selection unit 243 selects a suitable power transmission destination, based on the past electric energy consumption of the electrical appliances 31 to 34 which is stored in an electric energy consumption database 253 (described later).

The information management unit 244 stores weather information which is acquired from the weather information provider 5 through the communication unit 21, in the weather information database 251. The unit 244 stores information regarding the electric power generation in the power generation units 11 to 13 in the power generation electric energy database 252. The unit 244 stores information regarding the electric energy consumption in the electrical appliances 31 to 34.

The database 25 includes the weather information database 251, the power generation electric energy database 252, and the electric energy consumption database 253.

The weather information database 251 stores weather information which is acquired from the weather information provider 5 through the network 4. The weather information may be weather conditions (clear sky or rain) in time zones, temperature, humidity, wind velocity, chance of rain, precipitation, snowfall, typhoon information, and lighting information, by way of example. The weather information includes both wide-area weather forecast data issued by a public organization (Meteorological Agency or the like) and local forecast data issued by a private corporation. When the former weather forecast data is used, the weather information can surely be acquired because the information has been issued by the public organization. When the latter weather forecast data is used, an advantage is that high accuracy weather information near the building can be obtained, though depending on the corresponding range of the private corporation.

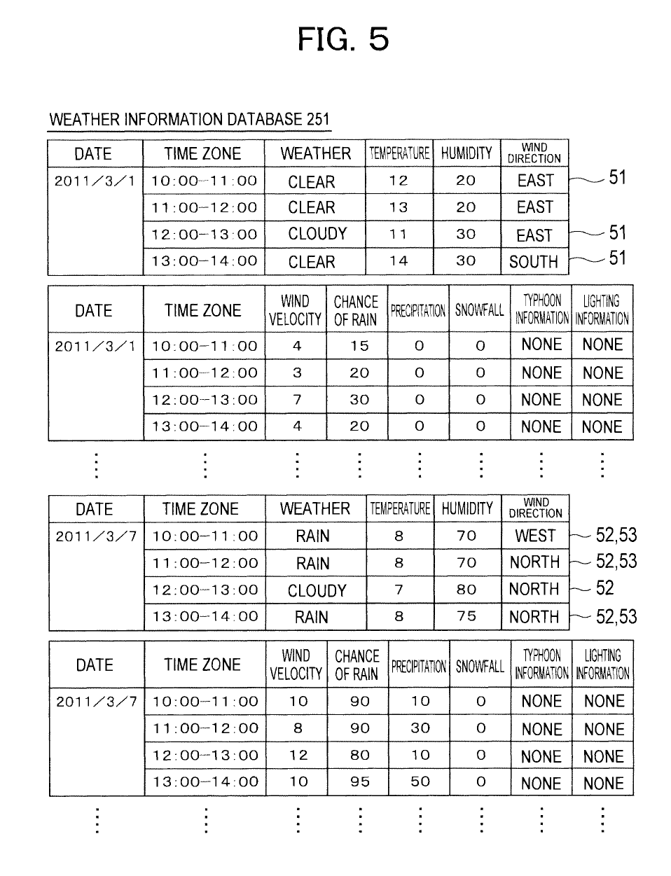

FIG. 5 is a diagram showing an example of the weather information database 251. For example, when the weather information provider 5 is the Meteorological Agency, the weather information is updated every few hours. Thus, there is a set table which stores data of time zones is stored.

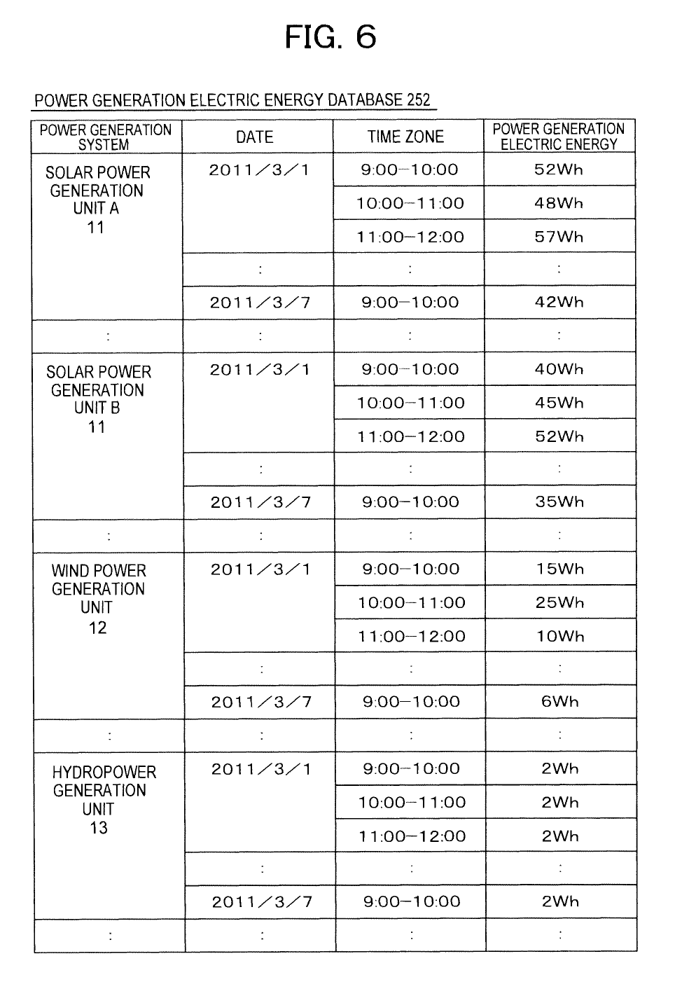

The power generation electric energy database 252 stores power generation electric energy of the power generation units 11 to 13 in association with the date and time zone. FIG. 6 shows an example of the power generation electric energy database 252.

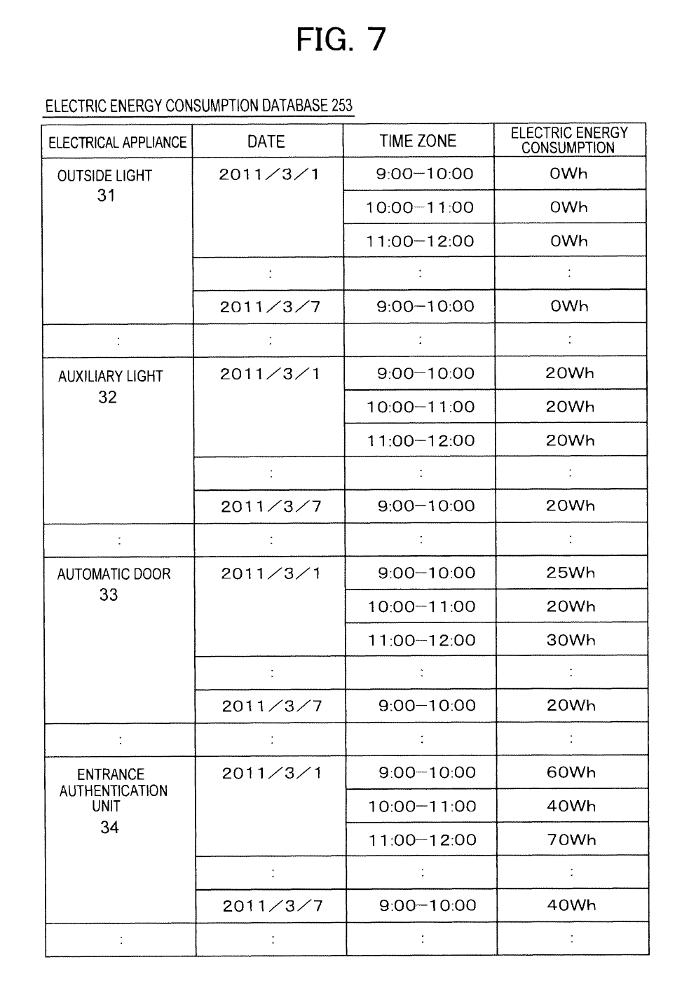

The electric energy consumption database 253 stores electric energy consumption of the electrical appliances 31 to 34 in association with the date and time zone. FIG. 7 shows an example of the electric energy consumption database 253.

The power control unit 2 of this embodiment selects a power generation unit with a high generating efficiency, by referring to the weather information. For example, in clear weather, the power generation unit selection unit 242 selects the solar power generation unit 11. On the other hand, in rainy weather, it selects the hydropower generation unit 13. The wind power generation unit can efficiently be operated by acquiring wind velocity information, while the hydropower generation unit 13 can efficiently be operated by acquiring precipitation information. At the approach of a typhoon, the wind power generation unit 12 is temporarily stopped, and lighting (strike) information is sent to the administrator upon reception of this information, in order to protect each of the power generation units from the strike of lighting. As a result, the power generation system 1 can efficiently be operated in accordance with the weather conditions.

Descriptions will now specifically be made to a process for selecting a power generation unit and a process for selecting a power transmission destination in this embodiment.

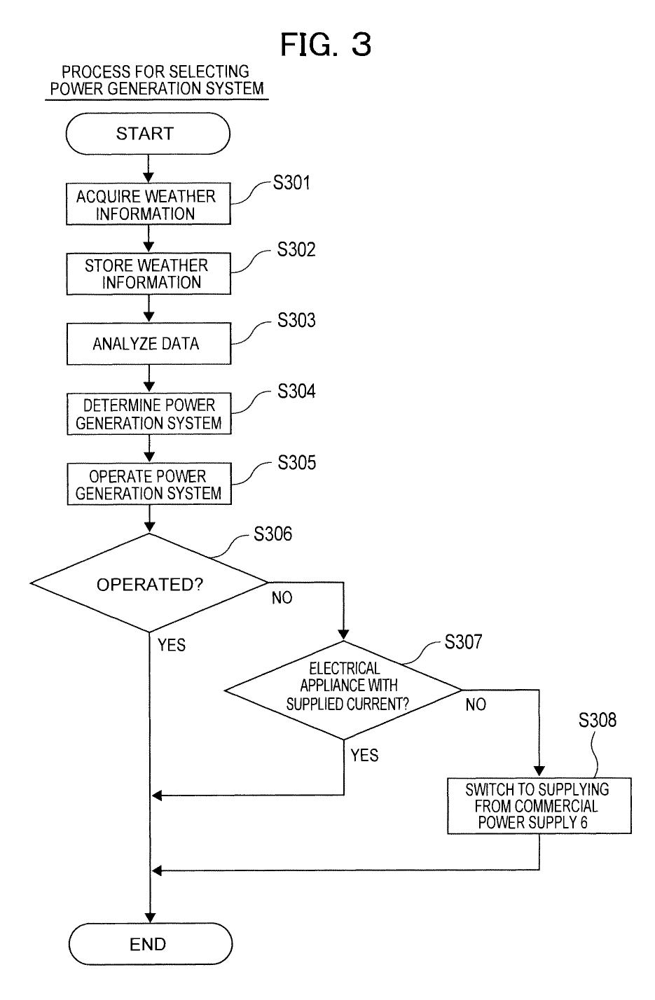

FIG. 3 is a diagram showing a flowchart of the process for selecting the power generation unit in the power generation unit selection unit 242.

The information management unit 244 periodically accesses the weather information provider 5 to acquire weather information (S301), and stores the acquired data in the weather information database 251 (S302). The administrator of the power control unit 2 sets a time interval for the information management unit 244 to access the weather information provider 5, for example, to every hour, through the input unit 22.

The power generation unit selection unit 242 analyzes the volume of sunshine duration, precipitation, and wind velocity of the next time zone, based on the weather information data stored in the weather information database 251 (S303), and determines a power generation unit with a high generating efficiency (s304).

The power generation unit selection unit 242 operates the power generation unit determined in S304 (S305), and determines whether the entire power generation units are normally operated (S306). The determination is made based on whether the generated electric energy of each corresponding power generation unit is greater than 0 W, by referring to the power generation electric energy database 252 after the operation. When determined that the entire power generation units are operated (Yes in S306), this process ends.

In S306, if the selected power generation units are not entirely operated (No in S306), the power transmission destination selection unit 243 determines whether each corresponding electrical appliance is electrically turned on, by referring to the electric energy consumption database 253 (S307). If the entire corresponding electrical appliances are electrically turned on, this process ends. On the contrary, if the entire corresponding electrical appliances are not electrically turned on, the power supplying is switched to power supplying from the commercial power supply 6 (S308).

Procedures of S303 and S304 will now specifically be described.

For example, in FIG. 5, the condition for operating the solar power generation unit 11 is satisfied in a time zone of a clear weather, as shown with a numeral 51. The condition for operating the wind power generation unit 12 is satisfied when the wind velocity is 8 m/s or higher, as shown with a numeral 52. The condition for operating the hydropower generation unit 13 is satisfied when it is a rainy weather, when it is a 50% chance of rain, and when the precipitation is higher than 0 mm, as shown with a numeral 53. If the conditions are satisfied, a plurality of power generation units may be operated. In the example of the illustration, the wind power generation unit 12 and the hydropower generation unit 13 are operated at the same time.

Accordingly, the power generation unit selection unit 242 selects a power generation unit in accordance with the weather condition, to realize efficient power generation.

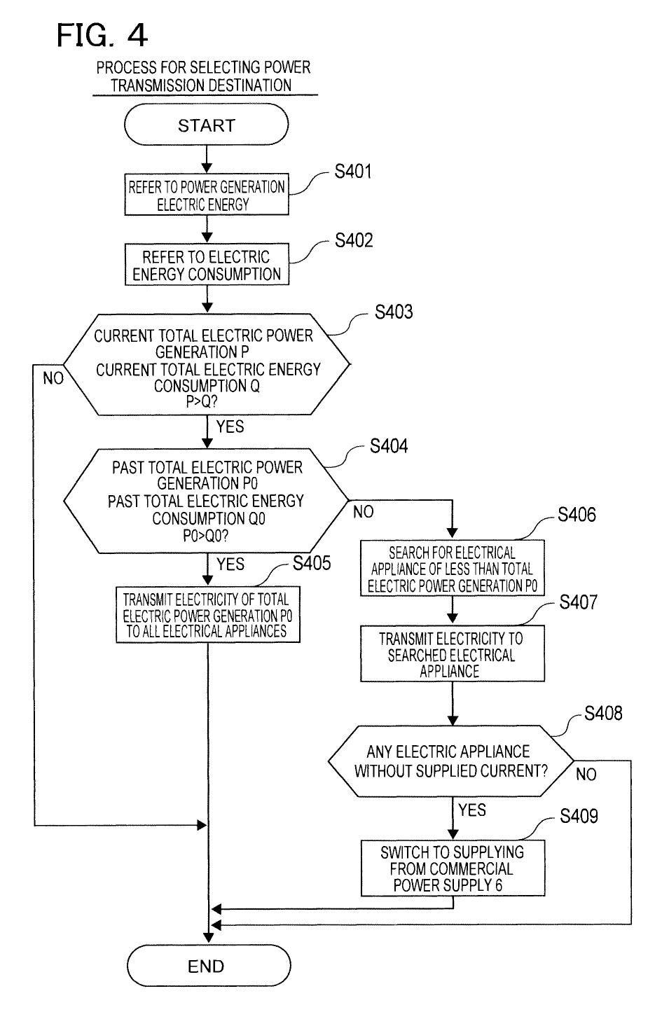

FIG. 4 is a diagram showing a flowchart of a process for selecting a power transmission destination in the power transmission destination selection unit 243. The power transmission destination selection unit 243 refers to the power generation electric energy database 252 to acquire data of the current electric power generation and the past electric power generation in association with each power generation unit (S401). The unit refers to the electric energy consumption database 253 to acquire data of the current electric energy consumption and the past electric energy consumption in association with each electrical appliance (S402).

The unit calculates the current total electric power generation P and the past total electric energy consumption Q based on the acquired data, and compares the both data (S403). When the current total electric power generation P is greater than the current total electric energy consumption Q (when P_{>}Q), the flow proceeds to S404. On the contrary, when the current total electric power generation P is lower than the current total electric energy consumption Q (when P<Q), the current power transmission destination is kept, and the process ends.

In S404, the unit calculates the past total electric power generation P₀ and the past total electric energy consumption Q₀ in a corresponding time zone based on the acquired data, and compares both data. When the past total electric power generation P₀ is greater than the past total electric power consumption Q₀ (when P₀>Q₀), the total generated electric power is transmitted to the entire electrical appliances (S405). On the contrary, when the past total electric power generation P₀ is lower than the past total electric energy consumption Q₀ (when P<Q₀), the flow proceeds to S406.

In S406, the unit refers to the electric energy consumption of each electrical appliance from the electric energy consumption database 253, and searches for any electric appliance whose electric energy consumption is lower than the total electric power generation P₀. At this time, a plurality of electric appliances may be searched out, and it is preferred that the selected electrical appliances are selected with a certain combination thereof that can attain the maximum total electric energy consumption. Then, electric power is transmitted to the searched electric appliances (S407).

Subsequently, the unit refers to the electric energy consumption database 253 to determine whether there is any electrical appliance that is not electrically turned on (S408). If the entire electrical appliances are electrically turned on, the process ends. If there is any electrical appliance that is not electrically turned on, power supplying is switched to power supplying from the commercial supply 6 (S409).

The above-described process for selecting the power transmission destination will now be described with a concrete example thereof.

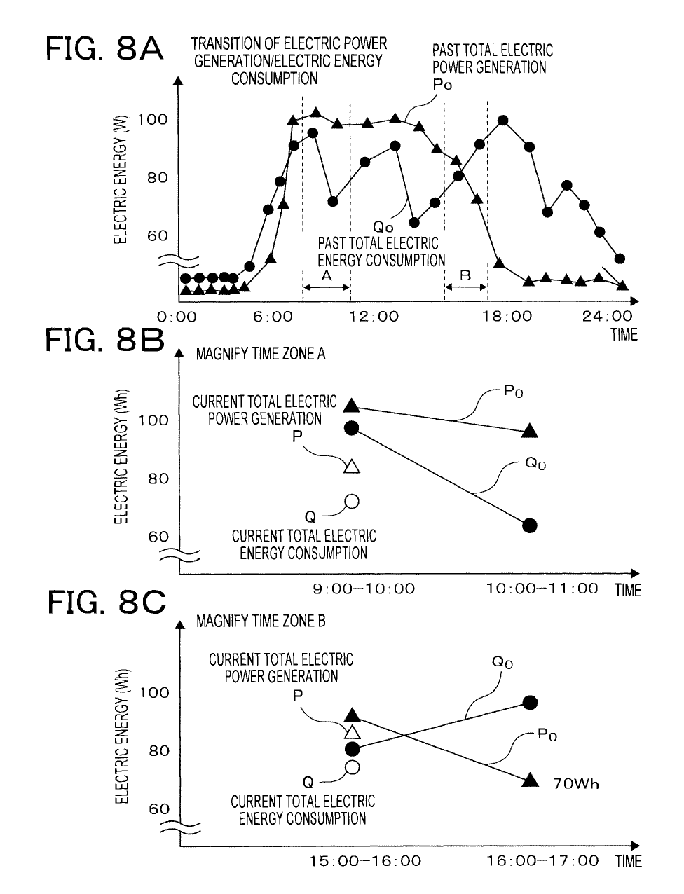

FIG. 8 are diagrams each showing an example of a time transition of the power generation electric energy and the electric energy consumption. The total electric power generation and the total electric energy consumption in the past-predetermined period (for example, one month is an enough time to understand the stable power status) are averaged, and are plotted as a time transition in one day, based on the power generation electric energy database 252 (FIG. 6) and the electric energy consumption database 253 (FIG. 7). FIG. 8A shows a transition of the total power generation P₀ and the total electric energy consumption Q₀ of the time zones in one day, FIG. 8B magnifies a time zone A, and FIG. 8C magnifies a time zone B. FIG. 8B and FIG. 8C show the current total power generation P and the total electric energy consumption Q that are plotted together with the above data.

For example, in FIG. 8B, descriptions will now be made to selection of a power transmission destination after 10:00, when the current time is just 10:00. An equation of P>Q is obtained, as a comparison result of the current total electric power generation P and the total electric energy consumption Q in the time zone between 9:00 and 10:00. An equation of P₀>Q₀ is obtained, as a comparison result of the past total electric power generation P₀ and the total electric energy consumption Q₀ in the next time zone between 10:00 and 11:00. Also in the time zone between 10:00 and 11:00, the electric power generation is considered to be sufficient in accordance with the above determinations of S403 and S404. Then, the flow proceeds to the procedure of S405, in which the entire power generation electric energy is transmitted to the electrical appliances.

Descriptions will now be made to selection of a power transmission destination after 16:00, when the current time is just 16:00, as shown in FIG. 8C. An equation of P>Q is obtained as a comparison result of the current total electric power generation and the total electric energy consumption Q in the time zone between 15:00 and 16:00. However, the reverse equation of P₀<Q₀ is obtained, as a comparison result of the past total electric power generation P₀ and the total electric energy consumption Q₀ in the next time zone between 16:00 and 17:00. The electric power generation is considered to be insufficient in the next time zone 16:00 and 17:00 in accordance with the above determinations of S403 and 404. Then, the flow proceeds to the above procedure of S406, in which a search is performed to an electrical appliance whose total electric power generation is lower than P₀. In this case, the total electric power generation P₀ in the time zone 16:00 and 17:00 is expected to be 70 Wh.

Descriptions will now be made to a concrete example of searching for a power transmission destination appliance.

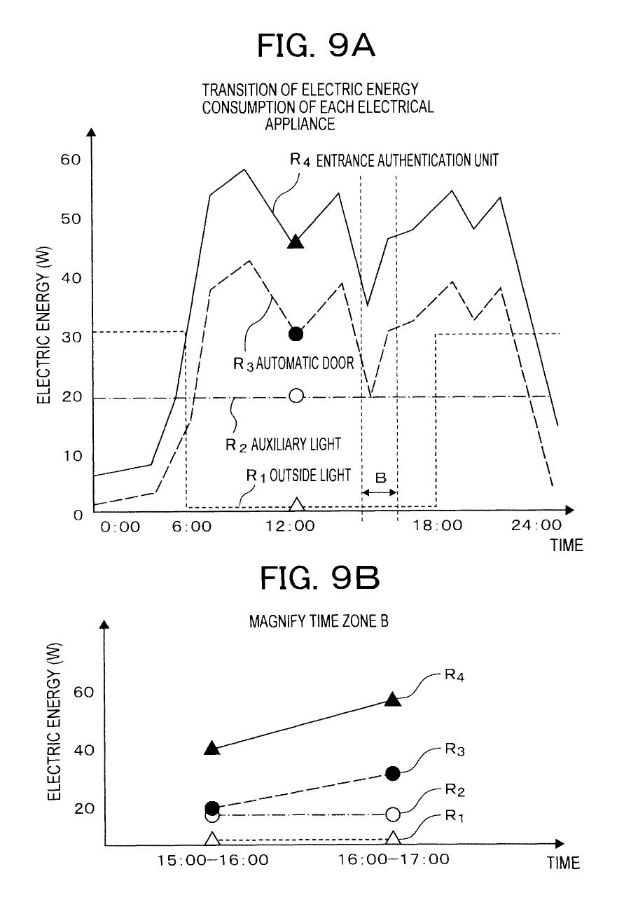

FIG. 9 are diagrams each showing an example of a time transition of the power consumption of each electrical appliance. The power consumption of each electrical appliance in a past predetermined period of time (for example, one month) is averaged, and is plotted as a time transition in one day, based on the electric energy consumption database 253 (FIG. 7). FIG. 9A shows a transition of the consumption R of each appliance in the time zones in one day, while FIG. 9B magnifies a time zone B. Of the electrical appliances, the outside light 31 (consumption R₁) is turned on only in the nighttime and in the early morning, and the auxiliary light 32 (consumption R₂) is always turned on.

Focusing on the time zone between 16:00 and 17:00, the sum of the electric energy consumption of the auxiliary light 32 (consumption R₂) and the automatic door 33 (consumption R₃) is 50 Wh. This amount is lower than the total electric energy consumption 70 Wh that is expected in FIG. 8C, in the time zone between 16:00 and 17:00. Thus, the power transmission destination selection unit 243 determines the auxiliary light 32 and the automatic door 33 as power transmission destination appliances to transmit electric power to only these appliances in S406. As a result, the total electric power generation 70 Wh can effectively be used in the time zone 16:00 and 17:00.

Accordingly, in this embodiment, in a building including a plurality of power generation units and a plurality of electrical appliances, both the power generation unit and the power transmission destination can efficiently be selected. Thus, the minimum amount of electricity is purchased from the commercial power supply 6, thus eliminating the electricity rate of the entire building.

Another effect is that the electric power generated by the power generation unit can be transmitted without AC conversion, thus resulting in only little loss in the power conversion. Because the system configuration can be made without installing the charging unit, thus realizing an inexpensive system architecture. The power generation scheme uses natural energy, thus eliminating the environmental loading.

The power control unit 2 of this embodiment is to execute both the selection of the power generation unit and the selection of the power transmission destination unit. However, the unit may execute only one of the selection processes.

### Second Embodiment

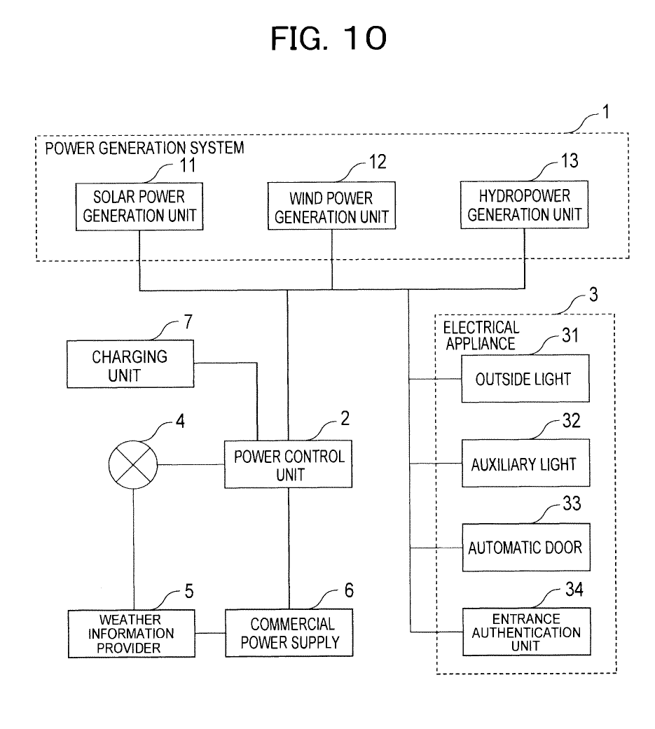

FIG. 10 is a whole block diagram showing a second embodiment of a power supply system which includes a power control unit of the present invention. In the first embodiment, the electric power generated by the power generation system has been transmitted to the electric appliances, as is. However, in this embodiment, the charging unit 7 is added, and the charging unit 7 is charged with the generated power once. Then, the power is supplied to the electrical appliances 3. Other configurations are the same as those of the first embodiment (FIG. 1). The power control unit 2 controls also the charging unit 7.

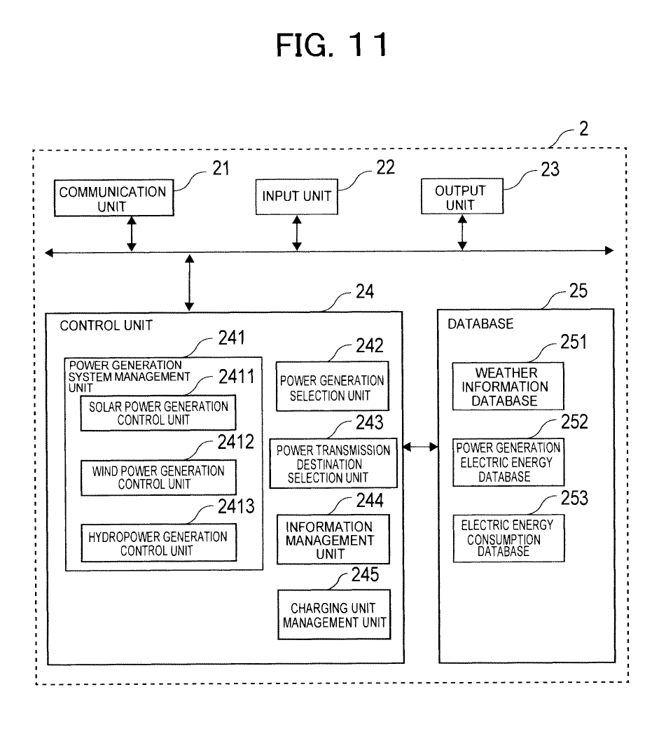

FIG. 11 is a block diagram showing an example of the power control unit 2. Added in the control unit 24 is a charging unit management unit 245 which controls the charging unit 7. The charging unit management unit 245 acquires information regarding the charging unit 7 through the information management unit 244, and controls the charging operation of the charging unit 7. Other configurations are the same as that of the first embodiment (FIG. 2). In this embodiment, the process for selecting a power generation unit is performed by the power generation unit selection unit 242, the process for selecting a power transmission destination is performed by the power transmission destination selection unit 243, and a charging control process is performed by the charging unit control unit 245. The process for selecting a power generation unit selection is the same as that of the first embodiment (FIG. 3), and thus will not be explained again. Descriptions will now be made to the charging control process and the power transmission destination selection unit of this embodiment.

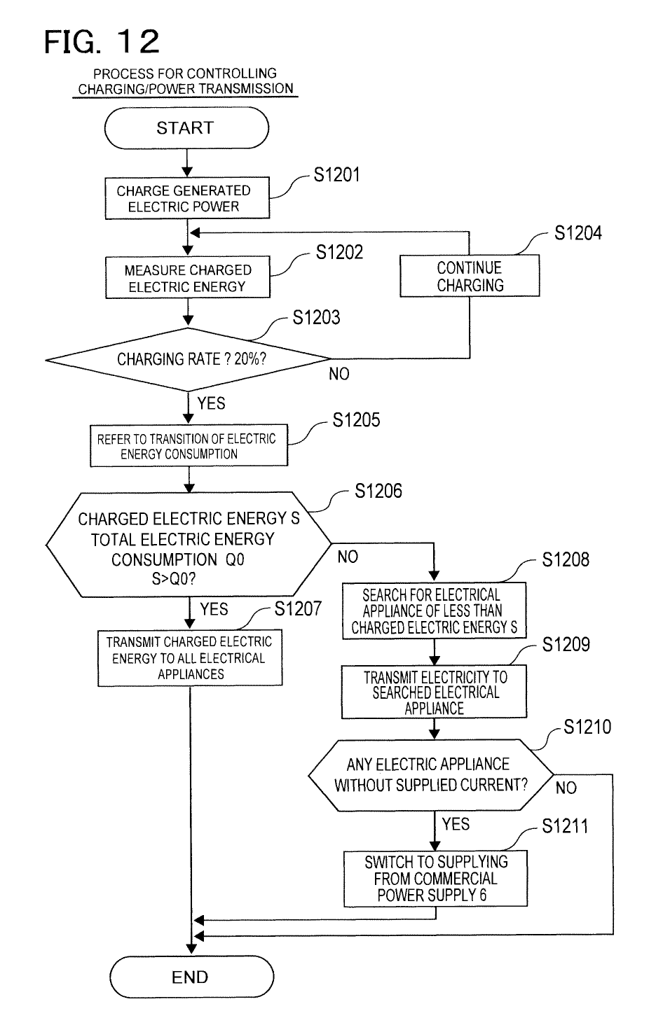

FIG. 12 is a diagram showing a flowchart of a charging process and a process for selecting a power transmission destination respectively by the charging unit management unit 245 and the power transmission destination selection unit 243.

The charging unit management unit 245 charges the charging unit 7 with generated electric power from the power generation system 1 (S1201). The charging unit management unit 245 measures the internal resistance and current of the charging unit 7 at a predetermined time interval, and measures the current charged electric energy (S1202). The ratio (charging rate) of the measured charged electric energy and the maximum amount of charged electric energy of the charging unit 7 is obtained. A determination is made as to whether the charging rate is equal to or greater than a threshold value (for example, 20%) (S1203). If the charging rate is lower than the threshold value, the charging operation continues (S1204), and the measurement is repeated until it reaches the threshold value. This is because the voltage of the charging unit 7 dramatically drops, if the charged electric energy is lower than the threshold value, resulting in unstable power supply.

If the charging rate is equal to or greater than the threshold value (20%), the power transmission destination selection unit 243 searches for a transition of the past electric energy consumption of a corresponding electrical appliance, by referring to the electric energy consumption database 253 (S1205). The unit compares the current charged electric energy S and the past total electric energy consumption Q₀ of the electrical appliance in a corresponding time zone (1206). When the current charged electric energy S is greater than the past total electric energy Q₀ (when S>Q₀), the power transmission destination selection unit 243 transmits the charged electric energy S to each electrical appliance, based on the same determination as S405 of FIG. 4 (S1207). On the contrary, if the current charged electric energy S is lower than the past total electric energy consumption Q₀ (when S<Q₀), the flow proceeds to S1208.

In S1208, like the same determination as S406 of FIG. 4, the unit searches for an electrical appliance whose electrical energy consumption is lower than the charged electric energy S, by referring to the consumption of each electrical appliance from the electric energy consumption database 253. Then, the unit transmits electricity to the searched electrical appliance (S1209).

Subsequently, the unit determines whether there is any electrical appliance which is not electrically turned on, by referring to the electrical energy consumption database 253 (S1210). If the entire electrical appliances are electrically turned on, the processes end. On the contrary, if there is any electrical appliance which is not electrically turned on, the power supplying is switched to power supplying from the commercial power supply 6 (S1211).

Accordingly, in this embodiment, the charging unit 7 is charged with the generated power, and an electrical appliance corresponding to the charged electric energy is preferentially used. This enables effective use of the appliance even with a small amount of charged electric energy. If a battery for electric vehicles is used as the charging unit 7, this system can be configured without a new battery in a building including the electric vehicle, thus attaining the effect of this embodiment.

### Third Embodiment

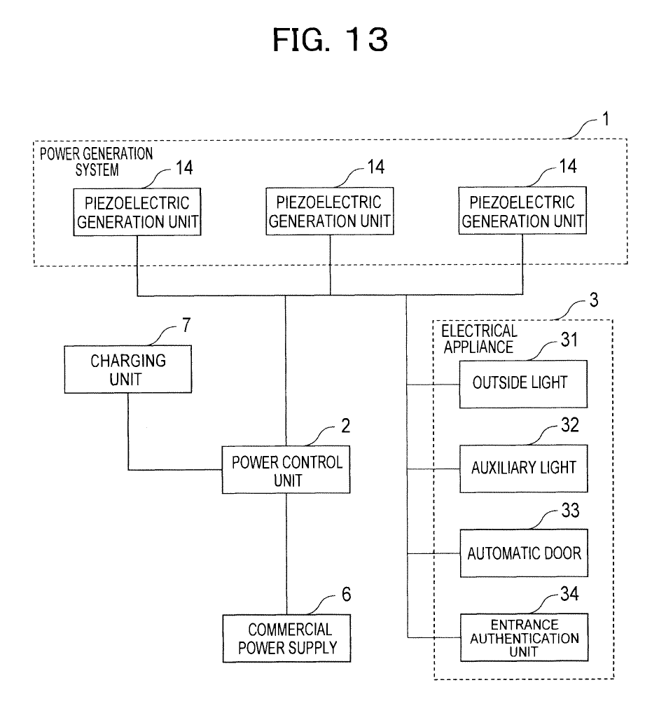

FIG. 13 is a whole block diagram showing a third embodiment of a power supply system in which the power control unit of the present invention is applied. In the above-described first and second embodiments, the power generation unit adapts a scheme using natural energy. However, this embodiment applies a piezoelectric power generation scheme using the step pressure of the user inside the building, and efficiently applies a power generation method in accordance with the behavioral pattern of the user.

The system configuration employs a piezoelectric generation unit 14 as the power generation system 1, charges the charging unit 7 with generated electric power from the piezoelectric generation unit 14, and transmits the power to the electrical appliance 3. The connection with the weather information provider 5 as described in the first and second embodiments is not made in this embodiment.

A plurality of piezoelectric generation units 14 are installed in the building, as the power generation system 1. The installation locations include, for example, the entrance of an apartment building, the common corridor toward the parking space, and the like. In the case of an office building, if the piezoelectric generation unit is installed at the entrance of a meeting room or restaurant suitable for dozens of people, many people pass on the piezoelectric generation unit 14, thus enabling efficient power generation.

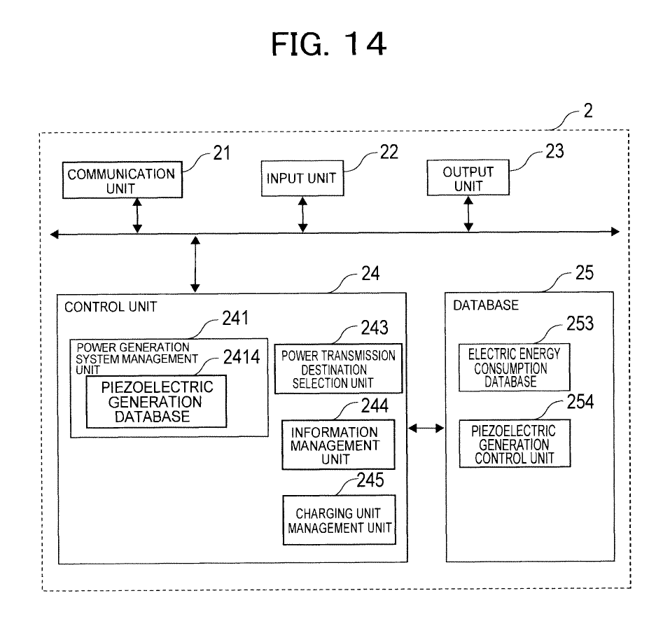

FIG. 14 is a block diagram showing one embodiment of the power control unit 2. Distinct features from the first and second embodiments are that a piezoelectric generation control unit 2414 is formed in the power generation management unit 241 of the control unit 24, and a piezoelectric generation database 254 is formed in the database 25. The piezoelectric generation control unit 2414 measures the electric energy generated by the piezoelectric generation unit 14 and the time zone for power generation, while the piezoelectric generation database 254 records the electric energy of the piezoelectric generation unit 14 that has been measured by the piezoelectric generation control unit 2414. The charging unit management unit 245 controls a charging operation for the charging unit 7 from the piezoelectric generation unit 14.

Descriptions will now be made to power generation control by the piezoelectric generation control unit 2414 and a charging control process by the charging unit management unit 245 in this embodiment.

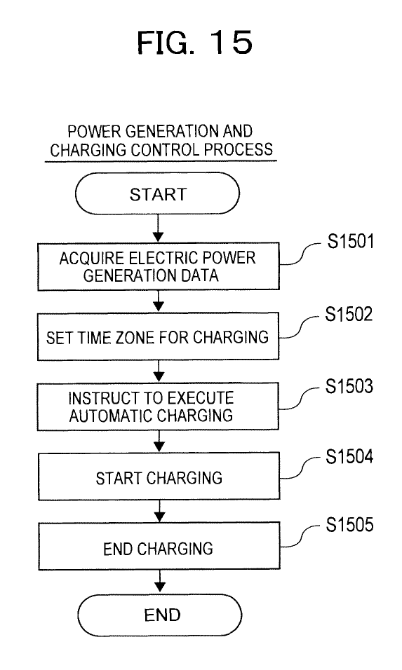

FIG. 15 is a diagram showing a flowchart of a power generation control process and a charging control process by the piezoelectric generation control unit 2414 and the charging unit management unit 245. This process includes a power generation time examination process, a charging time setting process, and an automatic charging process.

The piezoelectric generation control unit 2414 measures the power generated by the piezoelectric generation unit 14, and stores the measured data in the piezoelectric generation database 254 (S1501). That is, in a building including this system installed therein, examination about the electric power generation is made to see in which time zone and how much electric power generation could be realized by the piezoelectric generation unit 14. This is the power generation time examination process. The unit sets a time zone (chargeable time zone) in which the power generation electric energy is equal to or higher than a predetermined value for charging (S1502).

The charging unit management unit 245 instructs to automatically perform the charging operation for the charging unit 7 from the piezoelectric generation unit 14, in the chargeable time zone set in S1502 (S1503). This is the process for setting the charging time. When the system architecture software is based on Linux OS, as a system for the automatic execution process, an instruction command (for example, a “crontab” command) exclusive use for Linux is used, thereby enabling to periodically execute the instructed process. This eliminates the trouble in the system architecture.

The procedures from S1502 to S1503 may be executed only at the preparation of the system operation at the first time and when a change occurs in the time of the power generation.

The charging unit management unit 245 starts charging the charging unit 7 with electric power generated by the piezoelectric generation unit 14, at the charge start time (S1504). At the charge end time, the charging for the charging unit 7 with the power generated by the piezoelectric generation unit 14 ends (S1505). These procedures include the automatic charging process.

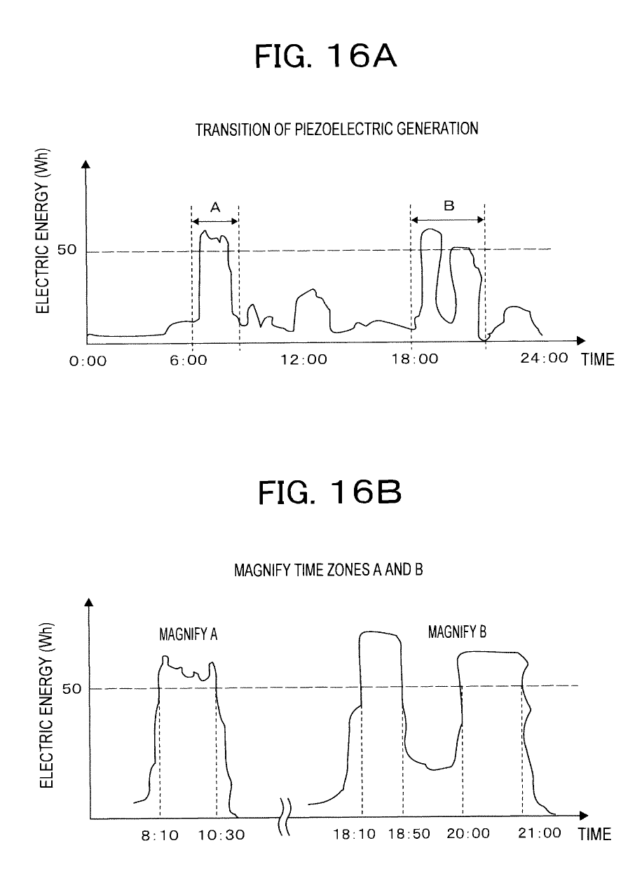

FIG. 16 are diagrams each showing an example of a time transition of power generation electric energy generated by the piezoelectric generation unit 14. In this example, the electric power generation in the past predetermined period of time (for example, one month) is averaged, and is plotted as a time transition in one day, based on the piezoelectric generation database 254. FIG. 16A shows a transition of electric power generation of the time zones in one day, while FIG. 16B magnifies the time zone A and the time zone B.

A reference value of the chargeable electric power generation is set, for example, to 50 Wh. In this case, the chargeable time zones in which the electric power generation exceeds a reference value are 8:00-10:30, 18:10-18:50, and 20:00-21:00. Only in these time zones, the charging is executed for the charging unit 7 from the piezoelectric generation unit 14. In other time zones, the charging is stopped.

In this embodiment, the process for selecting a power transmission destination is performed by the power transmission destination selection unit 243. This process is the same as that of the second embodiment (FIG. 12), thus will now be described again.

In this embodiment, the system uses the power generation unit, which generates only a small amount of electric power like the piezoelectric generation unit 14 as a power generation system and whose electric power generation depends on the behavioral pattern of the user, and realizes the following effect. By examining the electric power generation, it is possible to learn the behavioral pattern of the user using the building in which the piezoelectric generation unit 14 is installed and to efficiently perform the charging. That is, the automatic charging operation is performed only in a time zone in which the electric power generation is equal to or greater than a reference value, thus avoiding degradation of the charging unit due to too low charging voltage. Needless to say, the electric power generation and an amount of change can be increased, by learning the behavior of the user of the building, and installing the power generation unit in a location with a lot of traffic.

What is claimed is:

1. A power control unit which supplies electric power to an electrical appliance from a plurality of power generation units having different power generation schemes, comprising:
an information management unit which acquires weather information from a weather information provider;
a weather information database which stores the acquired weather information; and
a power generation unit selection unit which selects a power generation unit to be operated, by referring to the weather information database,
wherein the power generation unit selection unit selects a power generation unit with a high generating efficiency, of the plurality of power generation units in accordance with a current weather condition.

2. A power control unit which supplies electric power to a plurality of electrical appliances from a power generation unit, comprising:
an information management unit which acquires information regarding power generation electric energy of the power generation unit and electric power consumption of the plurality of electrical appliances;
a power generation electric energy database which stores the acquired power generation electric energy;
an electric power consumption database which stores the acquired electric power consumption; and
a power transmission destination selection unit which selects an electrical appliance to which power generated by the power generation unit is transmitted, by referring to the power generation electric energy database and the electric power consumption database,
wherein the power transmission destination selection unit selects an electrical appliance whose electric power consumption is less than the power generation electric energy, of the plurality of electrical appliances, when past power generation electric energy in a current time zone is lower than past total electric power consumption.

3. A power control unit which charges a charging unit with electric power generated by a power generation unit and supplies electric power to a plurality of electrical appliances, comprising:
a charging unit management unit which controls a charging operation for the charging unit from the power generation unit, and measures charged electric energy of the charging unit;
an information management unit which acquires information regarding electric energy consumption of the plurality of electrical appliances;
an electric energy consumption database which stores the acquired electric energy consumption; and
a power transmission destination selection unit which selects an electrical appliance which transmits charged electric power of the charging unit, by referring to the electric energy consumption database,
wherein the power transmission destination selection unit selects an electrical appliance whose electric energy consumption is less than the charged electric energy, from the plurality of electrical appliances, when current charged electric energy is lower than past total electric energy consumption in a current time zone.

4. The power control unit according to claim 3, wherein
the charging unit management unit continues a charging operation from the charging unit, until the charged electric energy of the charging unit reaches a predetermined threshold value.

5. A power control unit which charges a charging unit with generated power from a piezoelectric generation unit which generates electric power using step pressure of a passenger, comprising:
a piezoelectric generation control unit which controls the piezoelectric generation unit and measures power generation electric energy;
a piezoelectric generation database which stores the measured power generation electric energy; and
a charging unit management unit which controls a charging operation for the charging unit from the piezoelectric generation unit,
wherein the piezoelectric generation control unit sets a time zone in which power generation electric energy is equal to or greater than a reference value for charging, by referring to the piezoelectric generation database, and
wherein the charging unit management unit executes a charging operation for the charging unit from the piezoelectric generation unit, in the set time zone.
